(19) United States
(12) Patent Application Publication
(10) Pub. No.: US 2026/0338477 A1
(43) Pub. Date: Oct. 29, 2026

(54) Method For Controlling A Furnace During Pre-Drying Of At Least One Dental Restoration, Data-Processing Device, Computer Program, Computer-Readable Medium, Furnace, Method For Pre-Drying At Least One Dental Restoration And Use

(71) Applicant: Ivoclar Vivadent AG, Schaan (LI)

(72) Inventors: Gregor Beck, Schaan (LI); Rudolf Jussel, Gisingen (AT)

(21) Appl. No.: 19/655,906

(22) Filed: Apr. 23, 2026

(30) Foreign Application Priority Data
Apr. 24, 2025 (EP) 25172411.8

(51) Int. Cl. F27B 17/02; F27D 19/00

(52) U.S. Cl. CPC F27B 17/025; F27D 19/00; F27D 2019/0087

(57) ABSTRACT

A method for controlling a furnace during pre-drying of at least one dental restoration. The furnace includes a furnace base for supporting the dental restoration, and a furnace head that has at least one heating element. The method includes obtaining first data which describe a current furnace temperature and/or dynamics of the current furnace temperature. A closure position for the furnace is determined by a data model based on the first data. In addition, a movement of the furnace head and/or of the furnace base into the determined closure position is caused. A data-processing device, a computer program and a computer-readable medium are also presented. A furnace, a method for pre-drying at least one dental restoration and use of data which describe a current furnace temperature and/or dynamics of the current furnace temperature are presented.

### CROSS-REFERENCE TO RELATED APPLICATIONS

This application claims priority to European Patent Application No. 25172411.8 filed on Apr. 24, 2025, the disclosure of which is incorporated herein by reference in its entirety.

### TECHNICAL FIELD

The invention relates to a method for controlling a furnace during pre-drying of at least one dental restoration.

Furthermore, the invention relates to a data-processing device, a computer program and a computer-readable medium.

The invention also relates to a furnace for the thermal processing of at least one dental restoration.

In addition, the invention relates to a method for pre-drying at least one dental restoration by means of a furnace.

Furthermore, the invention relates to the use of data which describe a current furnace temperature and/or dynamics of the current furnace temperature.

### BACKGROUND

Dental restorations are frequently produced from ceramic materials. The dental restoration must thus be fired in a furnace during its production. This means that, under the influence of heat, a chemical reaction of the ceramic material and/or a conversion of the crystalline structure is caused, which is accompanied by a desired change in the material properties of the profile of the dental restoration, e.g. hardness. It is also possible to produce dental restorations by powder-metallurgical means, e.g. by sintering. In this case, under the effect of heat, a solid workpiece, i.e. a solid dental restoration, is produced from the so-called green body which is produced from compressed powder.

In both cases, it may be necessary to pre-dry the dental restoration prior to firing or sintering. This can assist the evaporation of liquid or, more generally, moisture which would be disruptive in the subsequent working steps. Pre-drying can also remove organic binders from the workpiece. A distinction is made between passive pre-drying and active pre-drying which differ from each other in that, during active pre-drying, heat is actively supplied to the workpiece to be dried, and this is not the case with passive pre-drying. Both pre-drying variants can take place in a furnace, e.g. the furnace used for firing or sintering, wherein this furnace is not actively operated during passive pre-drying. In a special case of passive pre-drying, however, residual heat of the furnace can be used for pre-drying. By reason of the fact that, during active pre-drying, heat is actively supplied to the workpiece, during active pre-drying an input of energy into the workpiece can be controlled better than during passive pre-drying. Less time is also generally required for active pre-drying. A disadvantage of active pre-drying compared with passive pre-drying is that, for reliable and efficient pre-drying, a user must adjust suitable parameters. To do so requires specialist knowledge and experience.

### SUMMARY

The object of the present invention is to simplify active pre-drying further.

The object is achieved by a method for controlling a furnace during pre-drying of at least one dental restoration. The furnace comprises a furnace base for supporting the dental restoration, and a furnace head which has at least one heating element. The method comprises:
obtaining first data which describe a current furnace temperature and/or dynamics of the current furnace temperature,
determining a closure position for the furnace by means of a data model based on the first data, and
causing a movement of the furnace head and/or of the furnace base into the determined closure position.

Using the data model it is thus possible, based on the first data, i.e. based on a current furnace temperature and/or dynamics of the current furnace temperature, to determine a closure position for the furnace which is suitable for pre-drying. Both the current furnace temperature and also the dynamics of the current furnace temperature, that is e.g. a rate of change of a current furnace temperature, are thus characteristic values which describe heat energy stored in the furnace from a prior process. A closure position of the furnace is further understood to be a relative position between the furnace base and furnace head. In relation to this, in addition to complete opening of the furnace, i.e. a configuration in which the furnace base and the furnace head are at a maximum distance from each other, and a state of complete closure of the furnace, i.e. a configuration in which the furnace is completely closed, relative positions of the furnace base and furnace head between these extremes are understood as closure positions. In relation to this, the furnace base can be designed to be stationary, wherein the furnace head can be moved relative to the stationary furnace base. Alternatively, the furnace head can be designed to be stationary, wherein the furnace base can be moved relative to the stationary furnace head. It is also possible for both the furnace base and also the furnace head to be movable. A closure position can be stated e.g. as a percentage, wherein 100% can correspond to complete opening of the furnace and 0% corresponds to the completely closed state. Conversely, it is also possible for 0% to correspond to the complete opening of the furnace and 100% to correspond to the completely closed state. Alternatively, it is also possible to describe a closure position by a distance between the furnace base and furnace head. Overall, the dental restoration can be pre-dried in a comparatively simple and reliable manner. By consideration of a current furnace temperature and/or dynamics of the current furnace temperature, efficiency in terms of time can also be increased during pre-drying. This is based on the fact that, in this way, it is possible to start pre-drying at the current furnace temperature, i.e. heating processes and cooling processes are not required. In this way, the process cycle time can be reduced, i.e. subsequent firings or subsequent sinterings can be started at shorter time intervals.

The method in accordance with the invention is thus, in particular, advantageous compared with known methods for controlling furnaces during pre-drying of dental restorations. With such methods, it is frequently necessary to input a plurality of pairs of temperatures and holding times in order to pre-dry the dental restoration in the desired manner.

A method in accordance with the invention can be carried out e.g. on a control device of a furnace which is suitable for pre-drying and then firing or sintering dental restorations.

In the context of the present invention, the furnace temperature is understood as a temperature in an interior of the furnace. This means that the furnace temperature describes a temperature of the gas, e.g. air, provided in the interior of the furnace. Depending on the situation, the furnace temperature may be different from a temperature of an object placed inside the furnace. According to one embodiment, the current furnace temperature is between ambient temperature, i.e. ca. 20 °C, and 950 °C. A temperature range from ca. 700 °C to 950 °C is typical for the firing of dental restorations made from ceramic and for the sintering of dental restorations. Depending on how long ago the last firing process or sintering process was performed, the current furnace temperature can typically be between 200 °C and 600 °C. For the case where the current furnace temperature is too low to pre-dry the dental restoration, the furnace can optionally be heated to the temperature which is suitable for pre-drying with the smallest possible opening. Therefore, reliable and efficient pre-drying can also be achieved when the furnace has previously not been in operation or has not been heated to a sufficiently high temperature for a prolonged period.

According to one embodiment, the method further comprises obtaining second data which describe a pre-defined heating rate for pre-drying. Alternatively, the second data comprise a heating rate for pre-drying, which is set by a user. Alternatively, in both alternatives, the closure position for the furnace is determined by means of the data model also on the basis of the second data. In the first alternative, the heating rate for pre-drying can be fixedly specified and thus e.g. can be stored in a control unit of the furnace. In this alternative, it is also possible for the precise heating rate not to be visible to a user. In this case, a user would merely have to initiate a pre-drying process and all further adjustments of the furnace could take place in an automated manner. In the second alternative, the user must set a heating rate for pre-drying. In so doing, different heating rates can optionally be provided to the user in a selection list and the user can select the desired heating rate from this selection list. In relation to this, the heating rate can be described by a numerical value, e.g. in Kelvin per unit of time. Alternatively, it is also possible to describe the heating rate in words, e.g. ‘high’, ‘medium’ and ‘low’ or ‘slow’ and ‘fast’. According to one example, the heating rate during pre-drying can be selected in dependence upon a subsequent heat treatment of the dental restoration, e.g. in dependence upon a subsequent firing process or a sintering process. The heating rate can be adjusted according to the user's opinion. In both alternatives, the dental restoration can be pre-dried in a comparatively simple and reliable manner.

According to one embodiment, the heating rates selected by the user are between 20 K/min and 60 K/min. It has proved to be the case that such heating rates are well suited to pre-drying dental restorations in a reliable and efficient manner.

The method can further comprise: causing the furnace temperature to be kept at the current furnace temperature or at a temperature calculated using the current furnace temperature. In one case, in which the furnace temperature is adjusted, the furnace temperature can be adjusted to the current furnace temperature or to the temperature calculated using the current furnace temperature. This means that the current furnace temperature or a temperature calculated using same is used as a target value of this adjustment. As already explained, the closure position is adjusted based on the data model. This has the advantage that the furnace neither has to be heated nor cooled at the start of pre-drying. Pre-drying can thus start comparatively quickly, independently of a current furnace temperature. This can lead to comparatively short process cycle times. Furthermore, the adjustment of the furnace to a constant temperature leads to an easily controllable pre-drying process which in turn leads to a reproducibly high quality for the dental restoration.

The method can also further comprise:
obtaining third data which describe a closure time set by the user, and
causing closure of the furnace when the set closure time expires.

Thus, the furnace can close gradually over a period of time until the closure time has been reached. The gradual closing can be described by a time sequence of closure positions. Alternatively, it is also possible for the furnace to close completely only once the end of the closure time has been reached. Typical closure times are between 1 minute and 60 minutes. This depends to a significant degree on the material system used. In both alternatives, reliable pre-drying can be achieved. Heat treatment of the dental restoration can start directly after closure.

In one case, in which the furnace assumes the determined closure position during pre-drying and is completely closed only once the end of the closure time has been reached, there is initially a linear increase in the temperature. With decreasing difference between the temperature of the dental restoration and the furnace temperature, the temperature increase in the dental restoration becomes increasingly flatter. If a constant, in particular linear, temperature increase in the dental restoration is desired, the closure position must be readjusted or the furnace temperature must be increased gradually. The latter also applies if a user has set a specific heating rate which is to be ensured over the closure time.

In a case where no closure time is set by the user, it is also conceivable for the closure position to be adapted dynamically in that the method in accordance with the invention is carried out multiple times.

The data model can be a trained data model. Such a data model is trained to output a closure position for the furnace based on first data, i.e. a current furnace temperature, and based on second data, i.e. a heating rate set by a user for pre-drying or a predefined heating rate for pre-drying. For this purpose, the data model can be trained using training data which include a plurality of data pairs, wherein each data pair comprises a first value which is a current furnace temperature, and comprises a second value which is a heating rate. The training data are annotated with data which describe a closure position. The closure position is selected so that the heating rate described by the second value in the data pair can be implemented. Such training data can be determined e.g. by trials. Alternatively, it is possible to generate the training data by means of a simulation. It is also possible to use both trials and also a simulation in order to generate the training data. An example of a trained data model is an artificial neural network. By using such trained data models, a closure position for the furnace can be determined easily and reliably in dependence upon the first data and the second data.

Alternatively or additionally, the data model can be a mathematical model. In this case, the data model describes a closure position for the furnace in dependence upon the first data and in dependence upon the second data using formulaic relationships. That data model can comprise one or more formulae, by means of which, with the aid of the first data and of the second data, the closure position can be determined. In this way, a suitable closure position can be determined in a simple and reliable manner.

In one example, the mathematical model comprises a polynomial function. By means of a polynomial function, a formulaic relationship between the closure position, the first data and the second data is described. Depending on the level of precision desired, the polynomial function can be a second-level, third-level or even higher level function. It has been shown that a data model which comprises a polynomial function constitutes a good compromise between precise determination of a suitable closure position and low demands for memory capacity and computing performance.

According to one variant, the data model can be based on the results of trials. The data model can therefore be wholly or partially matched to trial results or wholly or partially generated with the aid of trial results. The data model can be a trained data model or comprise a mathematical model. In both cases, the use of the trial results causes the data model to output a suitable closure position in a reliable manner.

The object is also achieved by means of a data-processing device which comprises means for carrying out the method in accordance with the invention for controlling a furnace during pre-drying of at least one dental restoration. Using such a data-processing device, a closure position for the furnace can thus be determined based on the first data, i.e. based on a current furnace temperature, in which closure position the desired pre-drying is achieved starting from the current furnace temperature and/or dynamics of the current furnace temperature. Overall, the dental restoration can be pre-dried in a comparatively simple and reliable manner. Furthermore, by consideration of a current furnace temperature, efficiency in terms of time is increased during pre-drying. This is based on the fact that, in this way, it is possible to start pre-drying at the current furnace temperature, i.e. heating processes and cooling processes are not required.

Furthermore, the object is achieved by a computer program which comprises commands which, when the computer program is being executed by a computer, cause the computer to carry out the method in accordance with the invention for controlling a furnace during pre-drying of at least one dental restoration. Using such a computer program, a closure position for the furnace can thus be determined based on the first data, i.e. based on a current furnace temperature, in which closure position the desired pre-drying is achieved starting from the current furnace temperature and/or dynamics of the current furnace temperature. Overall, the dental restoration can be pre-dried in a comparatively simple and reliable manner. By consideration of a current furnace temperature, efficiency in terms of time is also increased during pre-drying. This is based on the fact that, in this way, it is possible to start pre-drying at the current furnace temperature, i.e. heating processes and cooling processes are not required.

Furthermore, the object is achieved by a computer-readable medium which comprises commands which, when executed by a computer, cause this computer to carry out the method in accordance with the invention for controlling a furnace during pre-drying of at least one dental restoration. Using such a computer-readable medium, a closure position for the furnace can be determined based on the first data, i.e. based on a current furnace temperature, in which closure position the desired pre-drying is achieved starting from the current furnace temperature and/or dynamics of the current furnace temperature. Overall, the dental restoration can be pre-dried in a comparatively simple and reliable manner. By consideration of a current furnace temperature, efficiency in terms of time is also increased during pre-drying. This is based on the fact that, in this way, it is possible to start pre-drying at the current furnace temperature, i.e. heating processes and cooling processes are not required.

Furthermore, the object is achieved by a furnace for thermal processing of at least one dental restoration. The furnace comprises a furnace base for supporting the dental restoration, and a furnace head. The furnace base and the furnace head are movable relative to one another by means of at least one actuator. Furthermore, the furnace comprises a data-processing device in accordance with the invention, wherein the data-processing device is coupled in terms of control technology to the actuator. A closure position of the furnace is understood to be a relative position between the furnace base and furnace head. In relation to this, in addition to complete opening of the furnace, i.e. a configuration in which the furnace base and the furnace head are at a maximum distance from each other, and a state of complete closure of the furnace, i.e. a configuration in which the furnace is completely closed, relative positions of the furnace base and furnace head between these extremes are also understood as closure positions. In relation to this, the furnace base can be designed to be stationary, wherein the furnace head can be moved relative to the stationary furnace base. Alternatively, the furnace head can be designed to be stationary, wherein the furnace base can be moved relative to the stationary furnace head. It is also possible for both the furnace base and also the furnace head to be moveable. A closure position can be stated e.g. as a percentage, wherein 100% can correspond to complete opening of the furnace and 0% corresponds to the completely closed state. Conversely, it is also possible for 0% to correspond to the complete opening of the furnace and 100% to correspond to the completely closed state. Alternatively, it is also possible to describe a closure position by a distance between the furnace base and furnace head. Overall, the dental restoration can be pre-dried in a comparatively simple and reliable manner. By consideration of a current furnace temperature, efficiency in terms of time is also increased during pre-drying. This is based on the fact that, in this way, it is possible to start pre-drying at the current furnace temperature, i.e. heating processes and cooling processes are not required.

In addition, the object is achieved by a method for pre-drying at least one dental restoration by means of a furnace. The furnace comprises a furnace base for supporting the dental restoration, and a furnace head which has at least one heating element. During pre-drying, the furnace assumes a closure position which is determined by means of a method in accordance with the invention for controlling a furnace during pre-drying at least one dental restoration. This pre-drying method is particularly simple. Overall, the dental restoration can be pre-dried in a comparatively simple and reliable manner. By consideration of a current furnace temperature, efficiency in terms of time is also increased during pre-drying. This is based on the fact that, in this way, it is possible to start pre-drying at the current furnace temperature, i.e. heating processes and cooling processes are not required. This is also advantageous from the point of view of energy consumption. The energy available is used well.

The method for pre-drying at least one dental restoration can further comprise: keeping the furnace temperature at the current furnace temperature or at a temperature calculated using the current furnace temperature. In one case, in which the furnace temperature is adjusted, the furnace temperature can thus be adjusted to the current furnace temperature. This means that the current furnace temperature is used as a target value of this adjustment. As already explained, the closure position is adjusted based on the data model. This has the advantage that the furnace neither has to be heated nor cooled at the start of pre-drying. Pre-drying can thus start comparatively quickly, independently of a current furnace temperature. This can lead to comparatively short process cycle times. Furthermore, the adjustment of the furnace to a constant temperature leads to an easily controllable pre-drying process which in turn leads to a reproducibly high quality for the dental restoration.

The method for pre-drying at least one dental restoration can also further comprise: closing the furnace when a set closure time expires. Thus, the furnace can close gradually over a period of time until the closure time has been reached. Alternatively, it is also possible for the furnace to close completely only once the end of the closure time has been reached. Typical closure times are between 1 minute and 60 minutes. This depends to a significant degree on the material system used. Heat treatment of the dental restoration can start directly after closure.

Furthermore, the object is achieved by use of data which describe a current furnace temperature and/or dynamics of the current furnace temperature. They are used to determine a closure position of a furnace during pre-drying of a dental restoration. In this way, efficiency in terms of time can be increased during pre-drying. This is based on the fact that pre-drying can therefore start at the current temperature, i.e. it is possible to dispense with heating procedures and cooling procedures.

It will be understood that features, effects and/or advantages which have been mentioned in connection with one of the method in accordance with the invention for controlling a furnace during pre-drying, data-processing device in accordance with the invention, computer program in accordance with the invention, computer-readable medium in accordance with the invention, furnace in accordance with the invention, pre-drying method in accordance with the invention and use in accordance with the invention also apply to the respective others of the method in accordance with the invention for controlling a furnace during pre-drying, data-processing device in accordance with the invention, computer program in accordance with the invention, computer-readable medium in accordance with the invention, furnace in accordance with the invention, pre-drying method in accordance with the invention and use in accordance with the invention.

### BRIEF DESCRIPTION OF THE DRAWINGS

The invention will be explained hereinafter with the aid of various exemplified embodiments which are illustrated in the attached drawings, in which:

FIG. 1 shows a furnace in accordance with the invention with a data-processing device in accordance with the invention so that the furnace can be controlled by means of a method in accordance with the invention for controlling a furnace during pre-drying, and in addition a pre-drying method in accordance with the invention can be carried out, wherein the furnace assumes a first closure position,

FIG. 2 shows the furnace of FIG. 1, wherein the furnace assumes a second closure position,

FIG. 3 shows the furnace of FIGS. 1 and 2, wherein the furnace assumes a third closure position, and

FIG. 4 schematically illustrates a mathematical relationship between a current furnace temperature, a heating rate selected for pre-drying, and a closure position of the furnace.

### DETAILED DESCRIPTION

FIG. 1 shows a furnace 10 for thermal processing of a dental restoration 12. In relation to this, the furnace 10 can be designed e.g. as a baking furnace for a dental restoration 12 made of ceramic. Alternatively, the furnace 10 can be designed as a sintering furnace for a dental restoration 12 produced by powder-metallurgical means.

In the examples shown in the figures, only a single dental restoration 12 is illustrated by way of example. However, it will be understood that it is equally possible to dispose a plurality of dental restorations 12 for thermal processing in the inside of the furnace, i.e. in a furnace chamber 14.

The furnace 10 comprises a furnace base 16, on which the dental restoration 12 is supported.

Furthermore, the furnace 10 comprises a furnace head 18 in which a heating element 20, shown purely schematically, is disposed.

In the illustrated exemplified embodiment, the furnace base 16 is stationary.

The furnace head 18 is rotatably mounted on the furnace base 16 by means of a hinge 22.

The furnace head 18 can be driven by means of an actuator 24 which comprises e.g. an electric motor. This means that the furnace head 18 can be pivoted relative to the furnace base 16 by operation of the actuator 24.

Therefore, the furnace 10 can be opened and closed by means of the actuator 24, in that the furnace head 18 is raised from the furnace base 16 or is placed onto the furnace base 16 accordingly.

The furnace head 18 can also assume closing positions P relative to the furnace base 16, which are between complete closure of the furnace 10 and complete opening of the furnace 10.

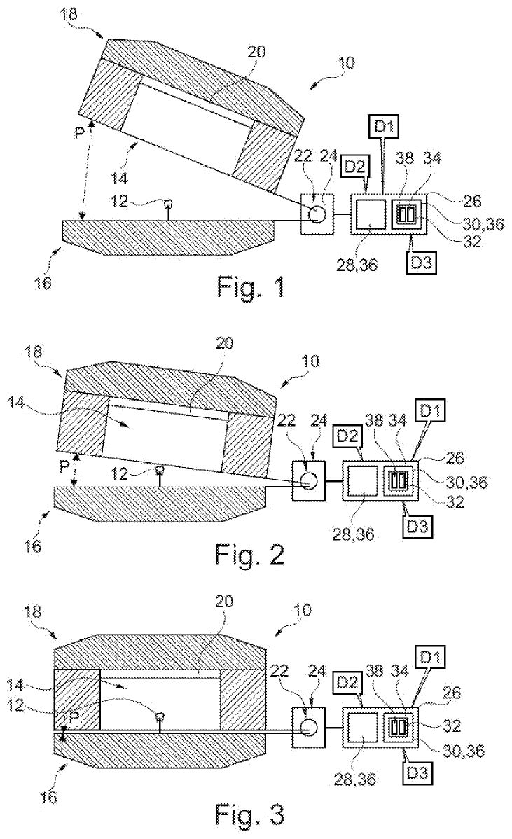

This is illustrated in FIGS. 1, 2 and 3, wherein, in the illustration of FIG. 1, the furnace 10 is opened to ca. 80%, in the illustration of FIG. 2 it is opened to ca. 40% and, in the illustration of FIG. 3, it is completely closed, i.e. 0% open. The closure position P is illustrated by means of a double arrow in these figures.

The furnace 10 also has a data-processing device 26 which is coupled in terms of control technology to the actuator 24 in order to control or adjust the operation of the actuator 24.

In relation to this, the data-processing device 26 comprises a computing unit 28 which can also be referred to as a processing unit, and a memory unit 30.

The memory unit 30 comprises a computer-readable medium or a non-transitory machine-readable medium 32.

A computer program 34 is stored on the computer-readable medium 32, i.e. also in the memory unit 30.

The computer program 34 and therefore also the computer-readable medium 32 comprise commands or computer instructions which, when executed by the computing unit or processor 28 or, more generally speaking, by a computer, cause this computer to carry out a method for controlling a furnace 10 during pre-drying.

The computing unit 28 and the memory unit 30 can therefore also be referred to as means 36 for carrying out a method for controlling a furnace 10 during pre-drying.

The method for controlling a furnace during pre-drying is explained in detail hereinunder.

In a first step of the method, first data D1 are obtained which describe a current furnace temperature T. The first data D1 can be provided e.g. from a temperature sensor, not shown in more detail, which measures a temperature inside the furnace chamber 14 and relays it via a control-technological connection to the data-processing device 26.

In a second step, second data D2 are obtained which describe a heating rate G, set by a user, for pre-drying. In relation to this, the user can generate the second data D2 via a user interface of the furnace 10. He/she can freely input the heating rate G for pre-drying via this user interface. Alternatively, he/she can select a desired heating rate G from a plurality of heating rates G provided for selection.

Thereafter, in a third step, a closure position P for the furnace 10 is determined. This is effected based on the first data D1 and on the second data D2 using a data model 38 which is stored on the computer-readable medium 32 in addition to the computer program 34. Alternatively, the data model 38 can also be designed as a component of the computer program 34.

In the illustrated embodiment, the data model 38 is a mathematical model in the form of a polynomial function.

The data model 38 thus has e.g. the following form, wherein the formula symbol T designates the current furnace temperature, the formula symbol G designates the heating rate and the letters a, b, c, d, e, f and g are coefficients.

$$P = a + b T + c {T}^{2} + d G + e {G}^{2} + f T G + g \frac{T}{G}$$

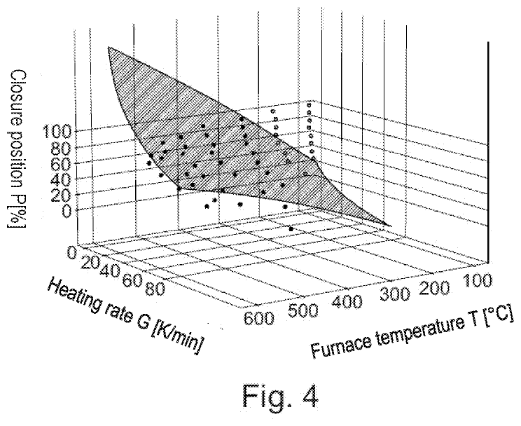

Such a polynomial function can be represented in three dimensions (see FIG. 4) as a plane.

Thus in the present case, the data model 38 is based on trial results. These trial results are depicted as dots in FIG. 4. The plane constitutes a regression plane which is based on the trial results and which can be described by means of the above-mentioned polynomial function by selection of suitable coefficients.

Therefore, with the aid of the polynomial function, in dependence upon the first data D1 and the second data D2, a closure position P can be determined.

Consequently, in a fourth step, the furnace head 18 is moved into the determined closure position P, i.e. by means of the data-processing device 26, a signal is sent to the actuator 24 which positions the furnace head 18.

Furthermore, in the course of the fourth step, the furnace temperature is adjusted to the current furnace temperature T, i.e. the furnace temperature T is kept at the temperature which the furnace 10 is currently at. This can be rendered dependent upon the current furnace temperature T being in a set range, e.g. 200 °C to 600 °C. For the case where the current furnace temperature T is outside this range, this can be adjusted to the respective next value of the set range. For example, in relation to this, the furnace temperature can be adjusted to 200 °C if the current furnace temperature T is below 200 °C and/or adjusted to 600 °C if the current furnace temperature T is above 600 °C.

In this way, the dental restoration 12 can be pre-dried comparatively simply with a high level of reliability, in particular by specifying only a single parameter, namely the heating rate G.

In relation to this, FIGS. 1 and 2 illustrate two possible scenarios.

In the example of FIG. 1, the current furnace temperature T may be e.g. 500 °C and a user may have specified a heating rate G of 40 K/min. This means that the second data D2 describe the heating rate G of 40 K/min and the first data D1 describe the furnace temperature T of 500 °C.

In this example, using the data model 38 a closure position P of 80% has now been determined and already adjusted in the representation of the furnace 10 illustrated in FIG. 1.

Pre-drying therefore takes place at a closure position P of 80%, wherein, at the same time, the furnace temperature T is kept at 500 °C.

In the example of FIG. 2, the current furnace temperature T can be e.g. 300 °C and a user may have specified a heating rage G of 40 K/min. This means that the second data D2 describe the heating rate G of 40 K/min and the first data D1 describe the furnace temperature T of 300 °C. The example of FIG. 2 thus differs from the example of FIG. 1 by the current furnace temperature T.

In this example, using the data model 38 a closure position P of 40% has now been determined and already adjusted in the representation of the furnace 10 illustrated in FIG. 2.

The pre-drying therefore takes place at a closure position P of 40%, wherein, at the same time, the furnace temperature T is kept at 300 °C.

Thus, both in the example of FIG. 1 and also in the example of FIG. 2, the same pre-drying process can be carried out.

Optionally, in the course of the method for controlling the furnace during pre-drying, third data D3 can also be obtained which describe a closure time set by the user.

As this closure time expires, closure of the furnace 10 is caused automatically, i.e. by means of the data-processing device 26 a corresponding control signal is sent to the actuator 24 which then moves the furnace head 18 relative to the furnace base 16 in such a way that the furnace 10 is completely closed.

Even though, in the present case, the method for controlling a furnace during pre-heating has been explained with the aid of a data model 38 which is implemented as a polynomial function, it will be understood that the data model 38 can also be of a different form.

In a specific alternative, the data model 38 is a trained data model, e.g. an artificial neural network. Using such a data model 38 and based on the first data D1 and the second data D2, a closure position P for the furnace 10 can also be determined reliably.

Consequently, a method for pre-drying at least one dental restoration 12 can be carried out by means of the furnace 10.

During the method, i.e. during pre-drying, the furnace 10 assumes a closure position P which has been determined by means of the above-described method for closing the furnace 10 based on the current furnace temperature T, i.e. the first data D1, and based on the set heating rate G, i.e. the second data D2.

Furthermore, as already explained, the furnace temperature is kept at the current furnace temperature.

After pre-drying is finished, the furnace 10 can be closed completely.

All in all, in the present case, data which describe a current furnace temperature T can thus be used to determine a closure position P of the furnace 10 during pre-drying of a dental restoration 12.

Data which describe a desired heating rate G during pre-drying are also used to determine a closure position P of the furnace 10 during pre-drying of a dental restoration 12.

### LIST OF REFERENCE SIGNS

10 furnace
12 dental restoration
14 furnace chamber
16 furnace base
18 furnace head
20 heating element
22 joint
24 actuator
26 data-processing device
28 computing unit
30 memory unit
32 computer-readable medium
34 computer program
36 means for carrying out a method for controlling a furnace during pre-drying
38 data model
D1 first data
D2 second data
D3 third data
G heating rate
T furnace temperature
P closure position

1. Method for controlling a furnace (10) during pre-drying of at least one dental restoration (12), wherein the furnace (10) comprises a furnace base (16) for supporting the dental restoration (12), and a furnace head (18) which has at least one heating element (20), comprising:
obtaining first data (D1) which describe a current furnace temperature (T) and/or dynamics of the current furnace temperature (T),
determining a closure position (P) for the furnace (10) by means of a data model (38) based on the first data (D1), and
causing a movement of the furnace head (18) and/or of the furnace base (16) into the determined closure position (P).

2. Method as claimed in claim 1, further comprising:
obtaining second data (D2) which describe a pre-defined heating rate (G) for pre-drying or a heating rate (G) set by a user for pre-drying, wherein the closure position (P) for the furnace (10) is determined by the data model (38) further based on the second data (D2).

3. Method as claimed in claim 1, further comprising:
causing the furnace temperature to be kept at the current furnace temperature (T) or at a temperature calculated using the current furnace temperature (T).

4. Method as claimed in claim 1, further comprising:
obtaining third data (D3) which describe a closure time set by the user, and
causing closure of the furnace (10) when the set closure time expires.

5. Method as claimed in claim 1,
wherein the data model (38) is a trained data model.

6. Method as claimed in claim 1,
wherein the data model (38) is a mathematical model.

7. Method as claimed in claim 6,
wherein the mathematical model comprises a polynomial function.

8. Method as claimed in claim 1,
wherein the data model (38) is based on trial results.

9. Data-processing device (26) comprising
means (36) for carrying out the method as claimed in claim 1.

10. Computer program (34) comprising commands which, when the computer program (34) is being executed by a computer, cause the computer to carry out the method as claimed in claim 1.

11. Computer program product (32) comprising program code which is stored on a non-transitory machine-readable medium, the machine-readable medium comprising computer instructions executable by a processor, which computer instructions cause the processor to perform the method according to claim 1.

12. Furnace (10) for thermal processing of at least one dental restoration (12), comprising
a furnace base (16) for supporting a dental restoration (12), and
a furnace head (18),
wherein the furnace base (16) and the furnace head (18) are movable relative to one another by at least one actuator (24), and a data-processing device (26) as claimed in claim 9,
wherein the data-processing device (26) is coupled in terms of control technology to the actuator (24).

13. Method for pre-drying at least one dental restoration (12) by a furnace (10), wherein the furnace (10) comprises a furnace base (16) for supporting the dental restoration (12), and a furnace head (18) which has at least one heating element (20), wherein, during pre-heating, the furnace (10) assumes a closure position (P) which is determined by the method as claimed in claim 1.

14. Method as claimed in claim 13, further comprising:
keeping the furnace temperature at the current furnace temperature (T) or at a temperature calculated using the current furnace temperature (T).

15. Method as claimed in claim 13, further comprising:
closing the furnace (10) when a set closure time expires.

16. Method of using data which describe a current furnace temperature (T) and/or dynamics of the current furnace temperature (T) in order to determine a closure position (P) of a furnace (10) during pre-drying of a dental restoration (12).
